(19) United States
(12) Patent Application Publication
(10) Pub. No.: US 2014/0311523 A1
(43) Pub. Date: Oct. 23, 2014

(54) VEHICLE-MOUNTED FOOTWEAR CLEANING DEVICE

(71) Applicant: PATRICK K. BEST, HONEY GROVE, PA (US)

(72) Inventor: PATRICK K. BEST, HONEY GROVE, PA (US)

(21) Appl. No.: 14/218,130

(22) Filed: Mar. 18, 2014

Related U.S. Application Data
(60) Provisional application No. 61/788,336, filed on Mar. 15, 2013.

(51) Int. Cl. A47L 23/26; B60R 3/04

(52) U.S. Cl. CPC A47L 23/26; B60R 3/04
USPC 134/6; 15/246

(57) ABSTRACT

A footwear cleaning device for attachment to a vehicle having a passenger compartment and a frame running lengthwise under said passenger compartment, the cleaning device comprising a base for mounting to the frame; an arm having a proximate end and a distal end, the arm being pivotally or slideably operatively attached to the base at the proximate end; a cleaner connected to the distal end of the arm; and an actuator having a moving end attached to the arm, the actuator having an unactuated state and an actuated state, when in the unactuated state, the cleaner is a first distance from the base, when in the actuated state, the cleaner is a second distance from the base, wherein the second distance is greater than the first distance.

### CROSS REFERENCE TO RELATED APPLICATION

This application claims priority to U.S. Provisional Application No. 61/788,336, filed Mar. 15, 2013, all of which is hereby incorporated by reference.

### FIELD OF INVENTION

The present invention relates generally to a device for cleaning shoes and boots, and, more specifically, to a device for cleaning footwear that is adapted for mounting to a vehicle such as a truck or automobile.

### BACKGROUND OF INVENTION

Tracking mud and filth into vehicles is a problem for many people involved in construction, surveying, or any other occupation or recreation that involves traveling to a muddy or dirty location, traipsing around in the mud and dirt, and then getting back into the vehicle. Approaches for cleaning footwear before getting back into the vehicle have been met with limited success. For example, one approach involves using a brush stored in the passenger compartment or trunk of the vehicle to clean footwear before getting into the vehicle. Although this may help to some degree in reducing the amount of dirt and debris tracked into the vehicle, it is often difficult for the user to clean one boot and then the other without putting the first boot back down on the ground and thus soiling it again. Additionally, stowing the dirty brush in the passenger compartment or trunk tends to convey dirt into the vehicle.

Therefore, Applicants have identified the need for a device to enable a user to clean his or her shoes or boots, while avoiding the need to store the brush in the vehicle or put one foot on the ground while cleaning the other foot. The present invention fulfills this need among others.

### SUMMARY OF INVENTION

The present invention provides a robust, retractable footwear cleaner that is readily mounted onto or integrated into a vehicle. Specifically, the footwear cleaning device is sufficiently strong and rigid that it supports the weight of the user, allowing the user to step from the footwear cleaner into the passenger compartment without having to put his or her foot back on the ground. Synergistically, the footwear cleaner of the present invention also provides a step into the passenger compartment, which is particularly beneficial for vehicles that tend to be relatively high off the ground, such as trucks. The footwear cleaner is also retractable and stows under the passenger compartment when not in use, and, thus, does not contaminate the passenger compartment after use. Therefore, the present invention provides a footwear cleaning device which is stowed outside of the passenger compartment and allows the user to step directly from the device into the passenger compartment after use, thereby avoiding re-soiling of his or her shoes.

Accordingly, one aspect of the invention is a device adapted for connection to or integration into the frame of a vehicle under the passenger compartment, that provides a sturdy step into the passenger compartment thereby allowing the user to step directly into the passenger compartment immediately after cleaning his or her footwear. In one embodiment, the footwear cleaning comprises: (a) a base for mounting to the frame; (b) an arm having a proximate end and a distal end, the arm being pivotally or slideably operatively attached to the base at the proximate end; (c) a cleaner connected to the distal end of the arm; and (d) an actuator having a moving end attached to the arm, the actuator having an unactuated state and an actuated state, when in the unactuated state, the cleaner is a first distance from the base, when in the actuated state, the cleaner is a second distance from the base, wherein the second distance is greater than the first distance. Another aspect of the invention is a method for cleaning footwear in which the user cleans his or her footwear without stepping on the ground. In one embodiment, the method comprises: (a) inserting a first foot having footwear into a cleaner extending from under the passenger compartment; (b) cleaning the footwear on the first foot; (c) putting the first foot into the passenger compartment directly without putting it on the ground; (d) inserting a second foot having footwear into the cleaner; (e) cleaning the footwear on the second foot; and (f) putting the second foot into the passenger compartment directly without putting it on the ground.

### BRIEF DESCRIPTION OF DRAWINGS

FIG. 1 shows a perspective view of one embodiment of the footwear cleaning device of the present invention.

FIG. 2 shows one embodiment of the proximate end of the arm.

FIG. 3 shows the footwear cleaning device of FIG. 1 attached to a vehicle and in the actuated state.

### DETAILED DESCRIPTION

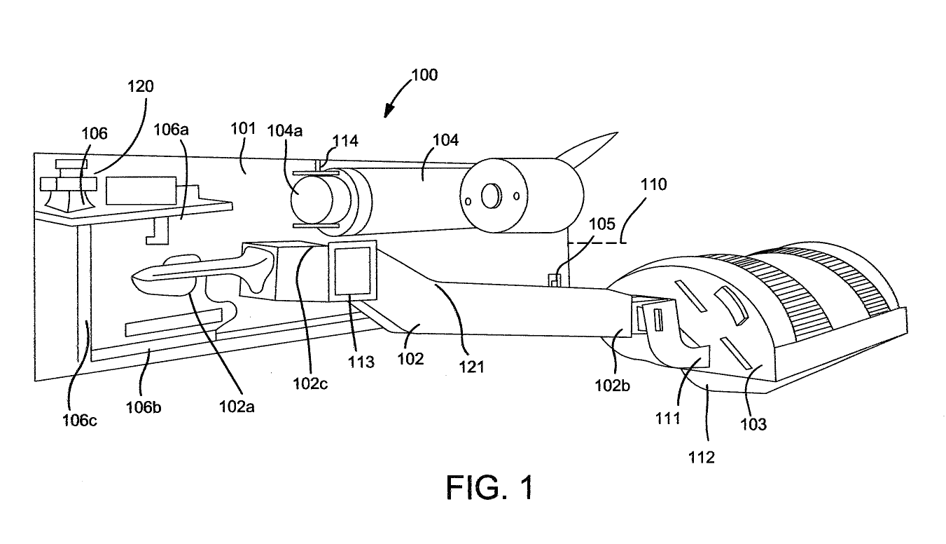

Referring to FIG. 1, one embodiment of the footwear cleaning device 100 of the present invention is shown. As used herein, the term “footwear” broadly refers to any article worn on the foot of a user and includes, for example, boots, shoes, slippers, clogs, sneakers/tennis shoes, flip-flops, etc. The footwear cleaning device 100 is adapted to be attached to—or integrated into—any vehicle having a passenger compartment and a frame running lengthwise under the passenger compartment. The term “vehicle” as used herein and refers broadly to any vehicle having a passenger compartment and a frame under the passenger compartment. Such a configuration is well-known and used extensively in trucks, SUVs, cars, farming equipment (e.g., tractors), and heavy equipment, such as bulldozers and tractors. The frame typically comprises a steel or aluminum beam that has a planar surface generally perpendicular to the road. The planar surface should have a surface area sufficient to accommodate the base. For example, a frame with a substantially planar surface of about 2-3 feet long and 6-10 inches wide has proven to be sufficient, although frames of different dimensions may be used depending upon the size of the base. Additionally, as described above, a substantially planar surface is not necessary, especially if this device is integrated into the vehicle frame.

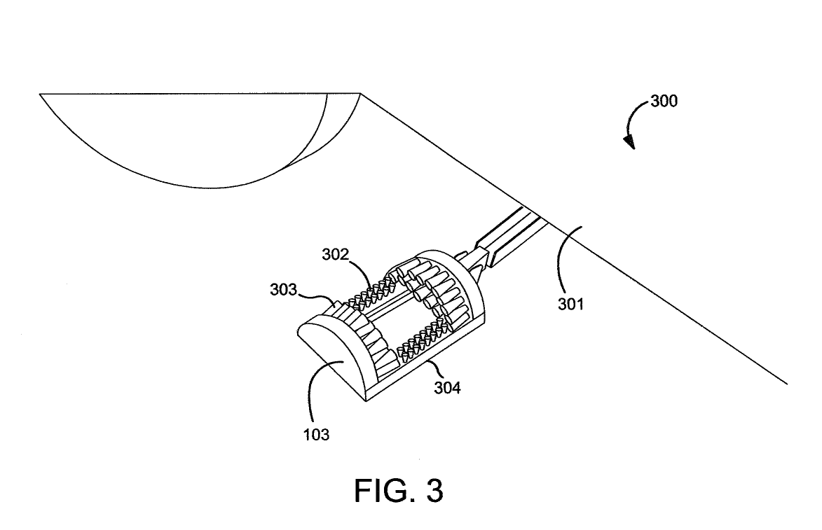

Referring to FIGS. 1 and 3, the cleaning device 100 comprises a base 101 for mounting to the frame of a vehicle, an arm 102, a cleaner 103, and an actuator 104. The arm 102 has a proximate end 102a and a distal end 102b. The proximate end of the arm is pivotally attached to the base 101, while the distal end is attached to the cleaner. The actuator 104 has a moving end 104a connected to the arm 102 between the proximate and distal ends 102a, 102b. The actuator 104 has an unactuated state and an actuated state. In the unactuated state, the arm is essentially parallel to the base (as shown in FIG. 1), while in the actuated state, the arm is angled with respect to the base such that the cleaner 103 extends beyond the passage compartment 301 of the vehicle 300 (as shown in FIG. 3), thereby providing a user with access to the cleaner 103. These elements are described in greater detail below.

The base 101 functions to secure the device 100 to the frame of the vehicle. To that end, the base 101 provides the substrate upon which the various components of the device 100 (such as the arm 102 and actuator 104) are connected, and, in one embodiment, is receptive to means for attaching the base 101 to the vehicle frame. Such means may include, for example, fasteners (such as bolts or screws), clamps, welding, and high-strength industrial adhesives. As shown in FIG. 1, the base 101 comprises bolt holes 120 for receiving bolts to connect the base 101 to the frame under the passenger compartment of a vehicle.

Rather than configuring the base to be connected to the frame as shown in FIG. 1, in other embodiments, it may be preferable to make the base integral with the frame. For example, if the device 100 is incorporated into the design of a new vehicle, the base 101 may be an integral component of the factory-supplied frame.

Referring back to FIG. 1, the base 101 comprises a flange 106 or other structural member for connecting to the proximate end 102a of the arm 102. As shown in FIG. 1, the flange 106 comprises a first and second flange member, 106a, 106b, interconnected by a flange web 106c. Such a configuration provides a very rigid structure to which the proximate end 102a is pivotally connected. In one embodiment, a pin (not shown) extends between the first and second flange members through the proximate end to provide the pivoting connection. In one embodiment in which the base is integral with the frame, the frame is configured to have the flange 106 as shown in FIG. 1.

In one embodiment, the base 101 is symmetrical about axis 10. By having the base 101 symmetrical about the axis 110, it can be mounted on the left or right side of the vehicle merely by flipping it over. For example, the embodiment pictured in FIG. 1 is intended for mounting on the left-side of the vehicle given the swing of the arm and the configuration of the cleaner 103. However, if the actuator 104 and the arm 102 are removed from the housing, the same base 101 can be attached to the right-side of the vehicle by merely flipping the base 101 upside down such that the flange member 106a, which is above flange member 106b as shown in FIG. 1, is below flange member 106b. Such a configuration reduces the need to inventory different parts for left and right mounting of the device.

In one embodiment, the base is adapted to be connected to the actuator. In one particular embodiment, the base 101 comprises first and second studs 105 symmetrically disposed on either side of axis 110 such that the actuator can be mounted on either stud depending on the orientation of the base—i.e. whether it is attached to the left right side of the vehicle. (It should be appreciated that although an embodiment is shown in FIG. 1 in which the actuator is connected to the base, other embodiments exist. For example, the actuator may be connected to another part of the vehicle, or, in the case of the actuator being a simple cable (described below), the end opposite of the moving end may be free.)

The arm 102 functions to rigidly connect the cleaner 103 to the vehicle through the base 101 and (in conjunction with the actuator 104) to position the cleaner for use. To this end, the arm 102 comprises a rigid material such as tube steel or aluminum. The tube may be any known tube configuration such as round tube or square tube.

As shown in FIG. 3, the length of the arm should be sufficient such that, when actuated, the cleaner 103 extends beyond the passage compartment of the vehicle to allow easy access for the user and to act as a step into the passenger compartment. In one embodiment, the arm has a maximum length such that the cleaner 103 does not extend past the vehicle's side mirrors to reduce the likelihood of the device 100 being actuated and hitting an next to the vehicle object (such as a parked car).

The arm 102 may have an angle 121, as shown in FIG. 1, to position the distal end—and thus the cleaner 103—closer to the ground as may be preferable in trucks and other vehicles which have frames located relatively high off the ground.

As mentioned above, the arm 102 is configured to extend the cleaner 103 beyond the passenger compartment in a readily-convenient position as shown in FIG. 3. The arm may be configured in different ways to perform this function. For example, in one embodiment, the arm is configured to extend essentially perpendicularly to vehicle. In such an embodiment, it may be preferable to use telescoping members in the arm. Alternatively, as shown in FIG. 1, the arm pivots out from the base.

The proximate end 102a may have a variety of different embodiments. In the embodiment in which the arm pivots from the base, the proximate end facilitates the pivoting. In one embodiment, the proximate end 102a comprises an adjustable joint which can be adjusted to change the angle of the arm relative to the base 101. Such functionality may be desirable to adjust the height of the cleaner 103 off the ground as described above. Such adjustment flexibility allows a single arm configuration to be used for a variety of vehicles having different frame heights.

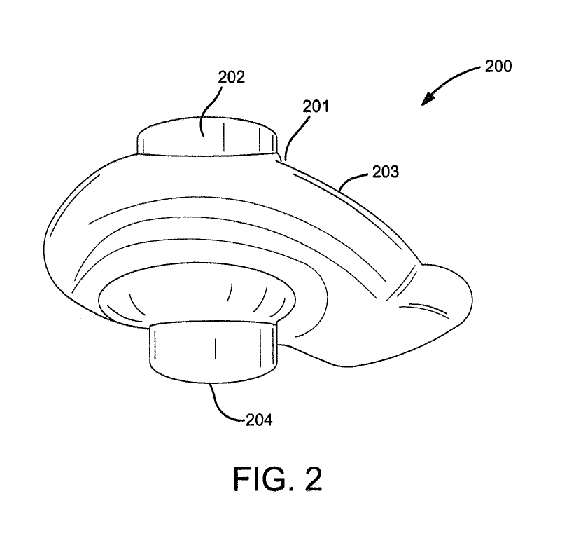

One embodiment of an adjustable proximate end 200 is shown in FIG. 2. The proximate end 200 in this embodiment comprises a ball joint 201 in which the ball component 202 is adjustable within an outer ring 203. In one embodiment, the ball component 202 defines a central passage 204 through which a pin (described above) is received such that, when the arm 102 is mounted to the base 101 and a pin runs between the first and second flange members 106a, 106b through the passage 205, the arm 102 pivots about the passage 205. Although the use of the ball joint 201 is shown in this embodiment, one with skill in the art will still appreciate that other configurations exist for angling the arm 102 with respect to the base 101.

The distal end 102b of the arm 102 is configured to be connected to the cleaner 103. A variety of configurations can be used for this purpose. In the embodiment shown in FIG. 1, the distal end 102b comprises a bayonet 111 which is received in a channel 112 of the cleaner 103. This configuration allows the cleaner 103 to be coupled to the arm by inserting the bayonet 111 into the channel 112 and then securing the bayonet therein. Such an embodiment facilitate easy removal of the cleaner 103 from the arm. The easy removal of the cleaner 103 is desirable as it allows for cleaning/replacement of the cleaner and even for interchanging different cleaners for different purposes. For example, in addition to the brush embodiment as shown in FIGS. 1 and 3, which depicts bottom and side brushes 302, 303 and a scrapper 304 (see FIG. 3), other cleaner configurations may include scrapers, or less abrasive cleaners such as a sponge or cloth for dress shoes/women's shoes. Still many other types of cleaners will be obvious to those of skill in the art in light of this disclosure.

The arm 102 also comprises a purchase point 102c for connection to the moving end 104a of the actuator 104. As will be obvious to those of skill in the art in light of this disclosure, the purchase point ought to be between the proximate and distal ends 102a, 102b and readily connectable to the moving end 104a of the actuator 104. In the embodiment shown in FIG. 1, the purchase point 102c is shown along the arm 102 to connect the actuator arm 104a to the arm 102. To this end, a window 113 is defined in the arm to provide access the purchase point 102c for fastening a fastener 114 between the arm and the actuator. The exact position of the purchase point along the arm 102 is a function of the length of the actuator 104 and other mechanical considerations such as the degree of force required to actuate the arm and hold it in the actuated position while the user is using the device. Although the actuator is connected above the arm in the embodiment of FIG. 1, it should be understood that other embodiments are possible and that the actuator may be connected to the bottom of the arm or to an extension extending from the arm.

The actuator 104 serves to move the arm 102 from its un-actuated position to its actuated position through the movement of the moving end 102a. In its un-actuated position, the arm 102 is essentially parallel to the base 101, thereby allowing it to tuck under the floor boards of a vehicle so as not to extend beyond the passenger compartment of the vehicle. In its actuated position, arm 102 swings away from the base 101 such that the cleaner 103 extends beyond the vehicle body as shown in FIG. 3 to allow the user to readily insert his or her footwear into it.

The actuator may have a variety of embodiments. For example, the actuator may be mechanical, electrical, pneumatic or hydraulic. In its simplest form, the actuator is mechanical and may be, for example, a simple cable, which is connected to a purchase point on the arm and is pulled by the user to move the arm into its actuated state. In such an embodiment, it may be preferable to provide a resilient force such as a torsional spring at the pivot point of the proximate end 102a or other spring on the arm to urge the arm into the unactuated state when not in use. Such an embodiment may also include means of locking the lock mechanism to hold the arm in its actuated state until the user is finished and then unlocking the arm such that it swings back into its un-actuated state by virtue of the resilient force mentioned above. The precise configuration of such an embodiment will be obvious to one of skill in the art in light of this disclosure.

In another embodiment, the actuator 104 is powered such that the actuation of the arm 102 can be automated. Such automation may be triggered, for example, by opening of the vehicle door. In one embodiment, the automate actuator 104 is interconnected with the open door relay that is used commonly to turn on lights in the passenger compartment. By interconnecting the actuator with this reply, opening the door will cause the actuator to extend the arm away from the base, while closing the vehicle door will the arm to retract into its un-actuated state. Such electrical interconnections are well known to those of skill in the art in light of this disclosure. Alternatively, the actuator may be triggered manually by a switch near the door, accessible by the user from the ground and in the cabin.

The actuator may be pneumatic in which case it may run off the compressed air supply of the host vehicle. Such pneumatic air supplies are common among commercial heavy equipment in larger trucks. Alternatively, pneumatic force may be available through a commercially available cylinder such as those used to open and control doors. Likewise, the actuator may be powered by hydraulic force provided by the vehicle's host hydraulic system, which are common in commercial and farming equipment. In the embodiment shown in FIG. 1, an electrical actuator 104 is used. Such actuators are commercially available. Such an electrical actuator may be powered by 12V DC or similar voltage available from the host vehicle.

The device in the present invention provides a strong and rigid footwear cleaning device. The rigidity is such that it can support the weight of a user, thereby allowing the user to clean his or her footwear without putting the cleaned footwear back on the ground. For example, the device 100 allows that user to place a first foot into the cleaner 103, clean it, step into the passage compartment with that foot, and then step into the cleaner 103 with the second foot, clean it, and then step directly into the passage compartment without having to put either foot back on the ground.

What is claimed is:

1. A footwear cleaning device for attachment to a vehicle having a passenger compartment and a frame running lengthwise under said passenger compartment, said cleaning device comprising:
a base for mounting to said frame;
an arm having a proximate end and a distal end, said arm being pivotally or slideably operatively attached to said base at said proximate end;
a cleaner connected to said distal end of said arm; and
an actuator having a moving end attached to said arm, said actuator having an unactuated state and an actuated state, when in said unactuated state, said cleaner is a first distance from said base, when in said actuated state, said cleaner is a second distance from said base, wherein said second distance is greater than said first distance.

2. The footwear cleaning device of claim 1, wherein said second distance is sufficient such that said cleaner extends beyond said passenger compartment.

3. The footwear cleaning device of claim 1, wherein said vehicle comprises a side-view mirror extending from said vehicle, and wherein said cleaner does not extend beyond said side-view mirror.

4. The footwear cleaning device of claim 1, wherein, said proximate end is pivotally connected to said base, such that, when in said unactuated state, said arm is essentially parallel to said base, and, in said actuated state, said arm is angled with respect to said base.

5. The footwear cleaning device of claim 1, wherein said actuator is at least one of manual, electric, pneumatic, or hydraulic.

6. The footwear cleaning device of claim 5, wherein said actuator is electric.

7. The footwear cleaning device of claim 1, further comprising said vehicle and wherein said base is attached to said frame.

8. The footwear cleaning device of claim 7, wherein said actuator is interlocked with a door-open reply of said vehicle such that, when said door is opened, said actuator is actuated to position said arm in said actuated state.

9. The footwear cleaning device of claim 1, wherein said base is symmetrical along its length such that it is adapted to be attached to either the left or right side of the vehicle.

10. The footwear cleaning device of claim 1, wherein said cleaner is releasibly engaged with said distal end.

11. The footwear cleaning device of claim 1, wherein said proximate end comprises an adjustable joint to adjust the vertical angle of said arm to said base.

12. The footwear cleaning device of claim 11, wherein said adjustable joint is a ball joint.

13. The footwear cleaning device of claim 1, wherein said cleaner is at least one of a brush, scrapper, sponge, or cloth.

14. A method of using a footwear cleaning device attached to a vehicle having a passenger compartment and a frame running lengthwise under said passenger compartment, said method comprising:
inserting a first foot having footwear into a cleaner extending from under said passenger compartment;
cleaning said footwear on said first foot;
putting said first foot into the passenger compartment directly without putting it on the ground;
inserting a second foot having footwear into said cleaner;
cleaning said footwear on said second foot; and
putting said second foot into the passenger compartment directly without putting it on the ground.

15. The method of claim 14, further comprising:
before putting said first foot into said cleaner, opening a door of said vehicle, thereby actuating said device to extend said cleaner beyond said passenger compartment, and
after putting said second foot in said passenger compartment, closing said door to retract said cleaner under said passenger compartment.
